(19) United States
(12) Patent Application Publication
(10) Pub. No.: US 2013/0215620 A1
(43) Pub. Date: Aug. 22, 2013

(54) ADJUSTING STRUCTURE FOR LED LAMP CAPABLE OF ADJUSTING LIGHT BEAM

(71) Applicant: Nanqing Zhou, Xiamen City (CN)

(72) Inventor: Nanqing Zhou, Xiamen City (CN)

(73) Assignee: MAINHOUSE (XIAMEN) ELECTRONICS CO., LTD., Fujian (CN)

(21) Appl. No.: 13/576,157

(22) PCT Filed: Nov. 9, 2010
(86) PCT No.: PCT/CN2010/078557

§ 371 Date: Jul. 30, 2012

(51) Int. Cl. F21V 21/14

(52) U.S. Cl. CPC F21V 21/14
USPC 362/285

(57) ABSTRACT

An adjusting structure for an LED lamp capable of adjusting the light beam includes a housing (1), an LED (2) fixed on the front end of the housing (1), a retractable adjusting seat (3) fitted on the outer side of the housing (1), and a convex lens (4) fixed on the outer end of the retractable adjusting seat (3). The convex lens (4) is positioned at the outer side of the LED (2). A rubber ring (5) is provided between the housing (1) and the retractable adjusting seat (3). Interference fits are formed between the rubber ring (5) and the housing (1) and the retractable adjusting seat (3) so as to generate damping between the retractable adjusting seat (3) and the rubber ring (5), thus a stepless adjustment is achieved.

### BACKGROUND OF THE INVENTION

1. Field of the Invention

The present invention relates to an LED lamp, and more particularly to an adjusting structure for an LED lamp capable of adjusting the light beam

2. Description of the Prior Art

A conventional LED lamp capable of adjusting the brightness and the range of the light beam comprises a convex lens in front of an LED. The distance between the convex lens and the LED is adjusted through an adjustment structure to adjust the focus and to adjust the light beam.

The adjustment structure uses screw-thread adjustment way, and comprises a stop member and a limit member to achieve multi-stop adjustment. The adjustment configuration is complicated and cannot achieve a stepless adjustment so the use is limited. Accordingly, the inventor of the present invention has devoted himself based on his many years of practical experiences to solve these problems.

### SUMMARY OF THE INVENTION

The primary object of the present invention is to provide an adjusting structure for an LED lamp capable of adjusting light beam. The adjusting structure has a simple configuration to achieve a stepless adjustment.

In order to achieve the aforesaid object, the adjusting structure for an LED lamp capable of adjusting light beam comprises a housing, an LED fixed on a front end of the housing, a retractable adjusting seat fitted on an outer side of the housing and a convex lens fixed on an outer end of the retractable adjusting seat. The convex lens is located at an outer side of the LED. A rubber ring is provided between the housing and the retractable adjusting seat. Interference fits are formed between the rubber ring and the housing and the retractable adjusting seat.

Preferably, the housing has a first limit face on a side wall thereof to stop an end face of the retractable adjusting seat. One end of the housing is provided with a stop board close to the LED. The retractable adjusting seat has a second limit face on an inner wall thereof corresponding to the stop board.

Preferably, an outer wall of the housing is provided with a plug and the retractable adjusting seat has a slide groove corresponding to the plug.

Thereby, the rubber ring is provided between the housing and the retractable adjusting seat. Interference fits are formed between the rubber ring and the housing and the retractable adjusting seat so as to generate damping between the retractable adjusting seat and the rubber ring. The retractable adjusting seat is moved up and down only by an external force. The retractable adjusting seat can be positioned at any position as desired to achieve a stepless adjustment. The configuration is very simple and the operation is very convenient.

### BRIEF DESCRIPTION OF THE DRAWINGS

FIG. 1 is a sectional view according to a preferred embodiment of the present invention;

FIG. 2 is a sectional view showing that the turning is stopped by the plug according to the preferred embodiment of the present invention; and

FIG. 3 is a perspective view according to the preferred embodiment of the present invention.

### DETAILED DESCRIPTION OF THE PREFERRED EMBODIMENTS

Embodiments of the present invention will now be described, by way of example only, with reference to the accompanying drawings.

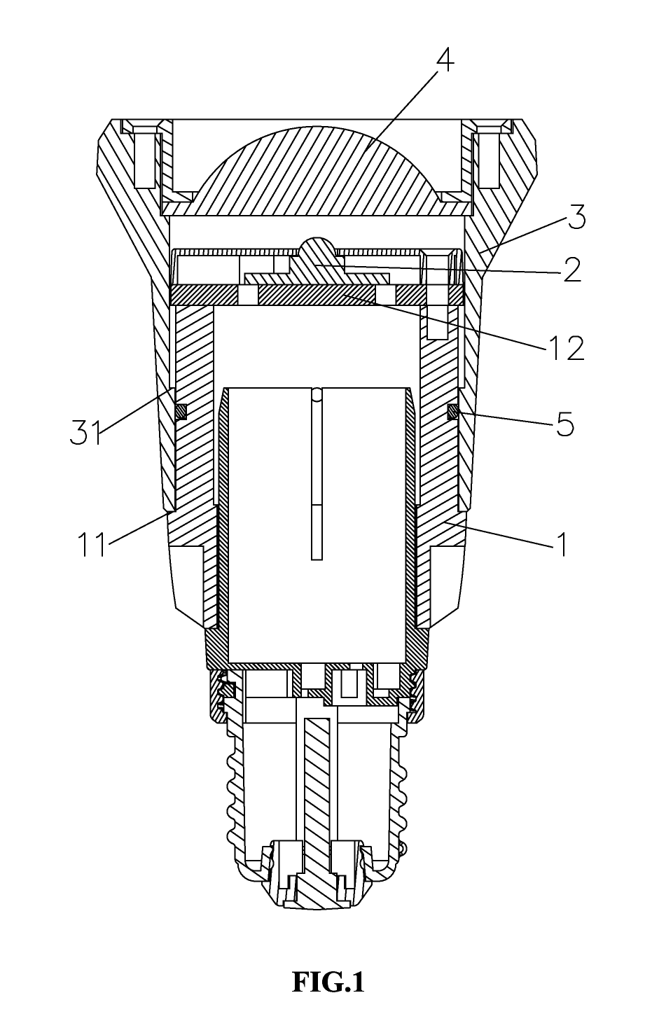

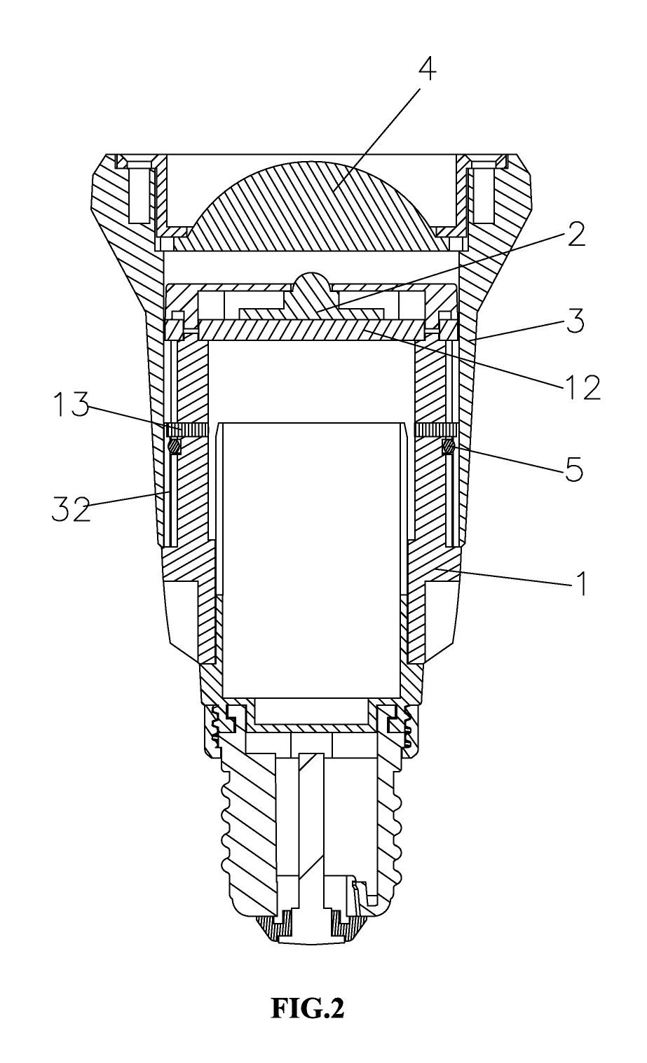

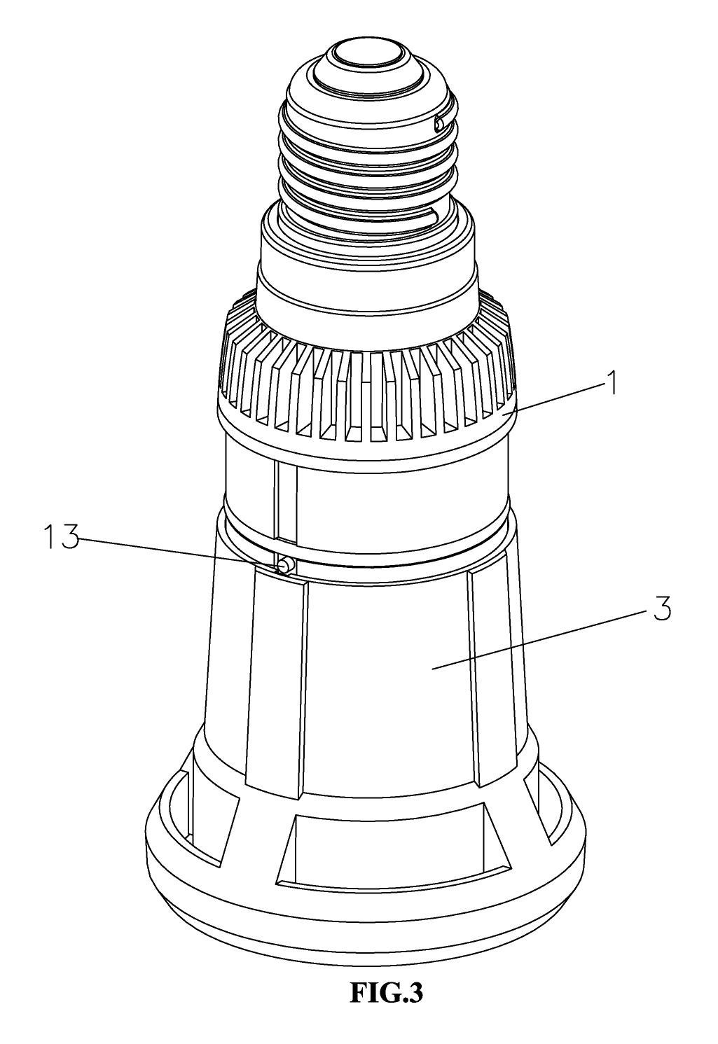

As shown in FIG. 1, FIG. 2 and FIG. 3, an adjusting structure for an LED lamp capable of adjusting the light beam according to a preferred embodiment of the present invention comprises a housing (1), an LED (2) fixed on the front end of the housing (1), a retractable adjusting seat (3) fitted on the outer side of the housing (1), and a convex lens (4) fixed on the outer end of the retractable adjusting seat (3). The convex lens (4) is located at the outer side of the LED (2).

A rubber ring (5) is provided between the housing (1) and the retractable adjusting seat (3). Interference fits are formed between the rubber ring (5) and the housing (1) and the retractable adjusting seat (3) so as to generate damping between the retractable adjusting seat (3) and the rubber ring (5). The retractable adjusting seat (3) is moved up and down only by an external force.

The housing (1) has a first limit face (11) on a side wall thereof to stop the end face of the retractable adjusting seat (3). One end of the housing (1) is provided with a stop board (12) close to the LED (2).

The retractable adjusting seat (3) has a second limit face (31) on an inner wall thereof corresponding to the stop board (12).

When making an adjustment, the retractable adjusting seat (3) is pulled outward. When the bottom of the stop board (12) is moved to the second limit face (31), the adjustment is stopped, namely, the adjustment is utmost. When the retractable adjusting seat (3) is pushed back and the end face of the retractable adjusting seat (3) gets contact with the first limit face (11), the adjustment is least. The position of the convex lens (4) relative to the LED (2) is changed in accordance with different positions of the retractable adjusting seat (3) to adjust the focus.

Furthermore, for the retractable adjusting seat (3) to be moved up and down only, not left and right, the outer wall of the housing (1) is provided with a plug (13) and the retractable adjusting seat (3) has a slide groove (32) corresponding to the plug (13) so that the turning of the retractable adjusting seat (3) is limited.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An adjusting structure for an LED lamp capable of adjusting light beam, comprising a housing, an LED fixed on a front end of the housing, a retractable adjusting seat fitted on an outer side of the housing and a convex lens fixed on an outer end of the retractable adjusting seat, the convex lens being located at an outer side of the LED; a rubber ring being provided between the housing and the retractable adjusting seat, interference fits being formed between the rubber ring and the housing and the retractable adjusting seat.

2. The adjusting structure for an LED lamp capable of adjusting light beam as claimed in claim 1, wherein the housing has a first limit face on a side wall thereof to stop an end face of the retractable adjusting seat, one end of the housing is provided with a stop board close to the LED, and the retractable adjusting seat has a second limit face on an inner wall thereof corresponding to the stop board.

3. The adjusting structure for an LED lamp capable of adjusting light beam as claimed in claim 1, wherein an outer wall of the housing is provided with a plug, and the retractable adjusting seat has a slide groove corresponding to the plug.
